(19) United States
(12) Patent Application Publication
(10) Pub. No.: US 2008/0068985 A1
(43) Pub. Date: Mar. 20, 2008

(54) Network redundancy method and middle switch apparatus

(75) Inventor: Hironori Mieno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KAWASAKI (JP)

(21) Appl. No.: 11/878,781

(22) Filed: Jul. 26, 2007

(30) Foreign Application Priority Data
Sep. 20, 2006 (JP) 2006-254421

(51) Int. Cl. H04L 12/24

(52) U.S. Cl. 370/217

(57) ABSTRACT

Each of an upper switch apparatus and lower switch apparatuses is connected to ports of a same port number of a pair of middle switch apparatuses by setting link aggregation, the pair of the middle switches are connected to each other via redundancy ports. When failure occurs at a port, connected to the lower switch apparatus, of one middles switch apparatus of the pair, the one middle switch apparatus adds input port information to a frame addressed to the failed port to transfer the frame to another middle switch apparatus of the pair from the redundancy port, and the another middle switch apparatus receives the frame from the redundancy port and transfers the frame in accordance with the input port information added to the frame.

### BACKGROUND OF THE INVENTION

1. Field of the Invention

The present invention relates to a network redundancy method and a middle switch apparatus. More particularly, the present invention relates to a redundancy method and a middle switch apparatus in a network including an upper apparatus, a plurality of middle switch apparatuses and a plurality of lower switch apparatuses.

2. Description of the Related Art

A switch apparatus such as a layer 2 switch (L2SW), a layer 3 switch (L3SW) and the like includes a MAC address learning function. According to this function, when the switch apparatus receives a frame, the switch apparatus obtains (extracts) a source MAC address, and stores the source MAC address into a FDB (Forwarding Database, which can be referred to as learning table) with an input port and VLAN information that is a VLAN ID (virtual LAN ID). This operation is called “learning”.

In addition, when a frame arrives, the switch apparatus obtains a destination MAC address and VLAN information, and searches the FDB to transfer the frame to a port corresponding to the MAC address and the VLAN information. When there is no corresponding entry, the frame is copied into a plurality of frames so that the frames are transferred to ports other than the input port among ports in which the VLAN information is set. This is called flooding.

In a switch apparatus, line bandwidth is added and line redundancy is realized using a link aggregation function. The link aggregation is a technique for aggregating a plurality of physical lines into a logical line. According to the link aggregation function, a frame destined for the logical line is distributed to one of a plurality of physical ports according to a predetermined rule. When failure occurs in a physical line that forms the link aggregation, communications are continued using other normal lines.

The switch apparatus can be classified to two types that are a box type and a chassis type. The box type switch is a card type in which a CPU and an interface unit are integrated. The chassis type includes a CPU and an interface unit as separate cards and each card is exchangeable. In addition, the interface unit can be added as necessary. The chassis type switch apparatus includes a plurality of cards, and, by realizing link aggregation among different cards, it is also possible to decrease effects to lines due to card failure. This function is called inter-card link aggregation function.

By the way, Japanese Laid-Open Patent Application No. 2005-175591 discloses a switching hub having an EoE (Ethernet over Ethernet) function and a redundant port function. When the switching hub detects that a failure occurs at a port, it sends a re-learning frame, from a port at which no failure occurs, for instructing another switching hub to re-learn address. When another switching hub receives the re-learning frame, the another switching hub relays the frame from other port, and re-learns an address from the re-learning frame.

In a wide area Ethernet, as shown in FIG. 1, edge switches 12 and 13 that are box type switches may be placed under an aggregation switch 11 that is a chassis type switch connected to a VWAN (Virtual Wide Area Network). In this case, when the number of users increases, the number of the edge switches placed below increases so that the number of ports of the aggregation switch 11 may become insufficient. When contracted bandwidth of each edge switch is narrow, there is a problem in that the number of ports lacks although switching capacity of the aggregation switch 11 is sufficient.

To solve this problem, as shown in FIG. 2, aggregation switches 15 and 16 that are chassis type switches may be added between the aggregation switch 11 and edge switches 12, 13 and 14. In this case, since the aggregation switches 15 and 16 are inserted and connected between the aggregation switch 11 and the edge switches 12-14 in which link aggregation is set, it is possible to change network configuration with minimum effects on the main signal. But, the added aggregation switches that are the chassis type are expensive compared with the box type switch. In addition, since the capacity of the chassis type switch is generally large, the system may become overengineered. In addition, when there is a surplus of switch capacity in the upper aggregation switch 11, there is a problem in that cost performance is low in terms of switch capacity.

In FIG. 2, if box type switches instead of the aggregation switches 15 and 16 are inserted between the aggregation switch 11 and the edge switches 12-14, link aggregation cannot be set between the box type switches replaced for the aggregation switches 15 and 16 and the edge switches 12-14, so that there is a problem in that redundant configuration cannot be taken.

As mentioned above, in the conventional technology, for increasing the number of ports of the aggregation switch in a network configuration shown in FIG. 1, the box type switch cannot be added as the aggregation switch while keeping the redundancy function without affecting existing lines.

In addition, a configuration shown in FIG. 3 can be considered in which box type switches 17-19 are connected to the aggregation switch 11 that is a chassis type switch to form a ring to realize ring protection capability. Accordingly, a redundancy configuration can be realized without using expensive chassis type switches 15 and 16. But, for changing the network configuration from the existing tree configuration shown in FIG. 1 to the ring configuration shown in FIG. 3, there is a problem in that existing operating lines are affected. In addition, there is a problem in that, for changing the network configuration, user lines are interrupted, or, the lines need to be aggregated using the chassis type switch that is expensive and that has no space merit.

### SUMMARY OF THE INVENTION

The present invention is contrived in view of the above-mentioned problem, and an object of the present invention is to provide a network redundancy method and a middle switch by which the box type switch can be used as a middle switch that is added for increasing the number of ports of the upper switch apparatus, redundancy function is realized, and it is not necessary to change settings of existing apparatuses.

According to an embodiment of the present invention, a redundancy method used in a network including an upper switch apparatus, a pair of middle switch apparatuses connected to the upper switch apparatus, and a plurality of lower switch apparatuses connected to each of the pair of middle switch apparatuses is provided.

In the method, each of the upper switch apparatus and the lower switch apparatuses is connected to ports of a same port number of the pair of the middle switch apparatuses by setting link aggregation;

the pair of the middle switches are connected to each other via redundancy ports;

when failure occurs at a port, connected to the lower switch apparatus, of one middles switch apparatus of the pair of the middle switch apparatuses, the one middle switch apparatus adds input port information to a frame addressed to the failed port to transfer the frame with the input port information to another middle switch apparatus of the pair from the redundancy port; and

the another middle switch apparatus receives the frame with the input port information from the redundancy port and transfers the frame in accordance with the input port information.

According to another embodiment of the redundancy method, each of the upper switch apparatus and the lower switch apparatuses is connected to ports of a same port number of the pair of the middle switches by setting link aggregation;

the pair of the middle switches are connected to each other via redundancy ports;

when failure occurs at a port, connected to the lower switch apparatus, of one middle switch apparatus of the pair of the middle switch apparatuses, the one middle switch apparatus adds output port information to a frame addressed to the failed port to transfer the frame with the output port information to another middle switch apparatus of the pair from the redundancy port; and

the another middle switch apparatus receives the frame with the output port information from the redundancy port and transfers the frame in accordance with the output port information.

According to the present invention, the box type switch can be used as a middle switch that is added for increasing the number of ports of the upper switch apparatus, redundancy function is realized, and it is not necessary to change settings of existing apparatuses.

### BRIEF DESCRIPTION OF THE DRAWINGS

Other objects, features and advantages of the present invention will become more apparent from the following detailed description when read in conjunction with the accompanying drawings, in which:

FIG. 1 shows a configuration example of a conventional network;

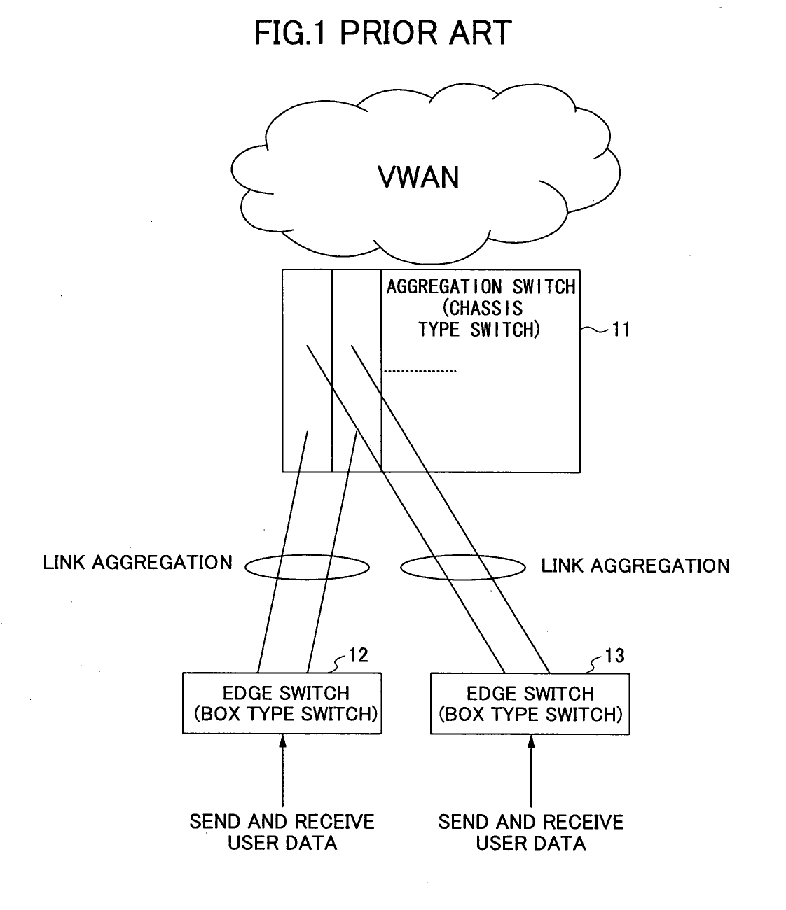

FIG. 2 shows another configuration example of a conventional network;

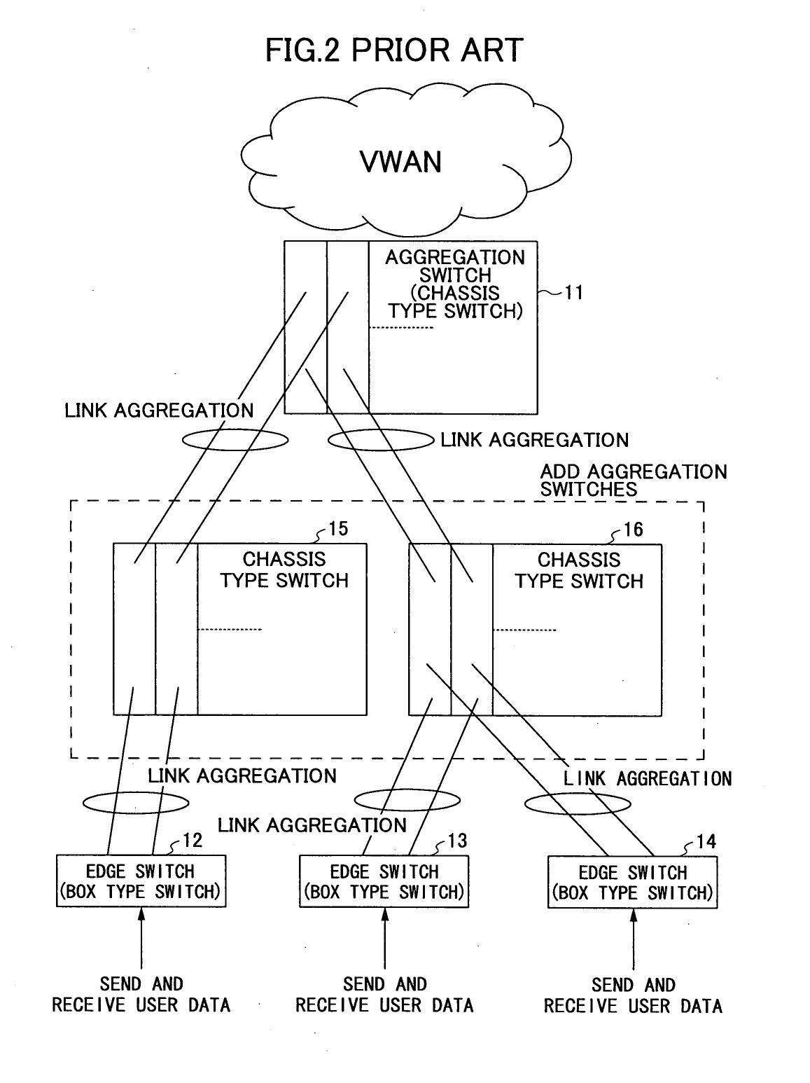

FIG. 3 shows another configuration example of a conventional network;

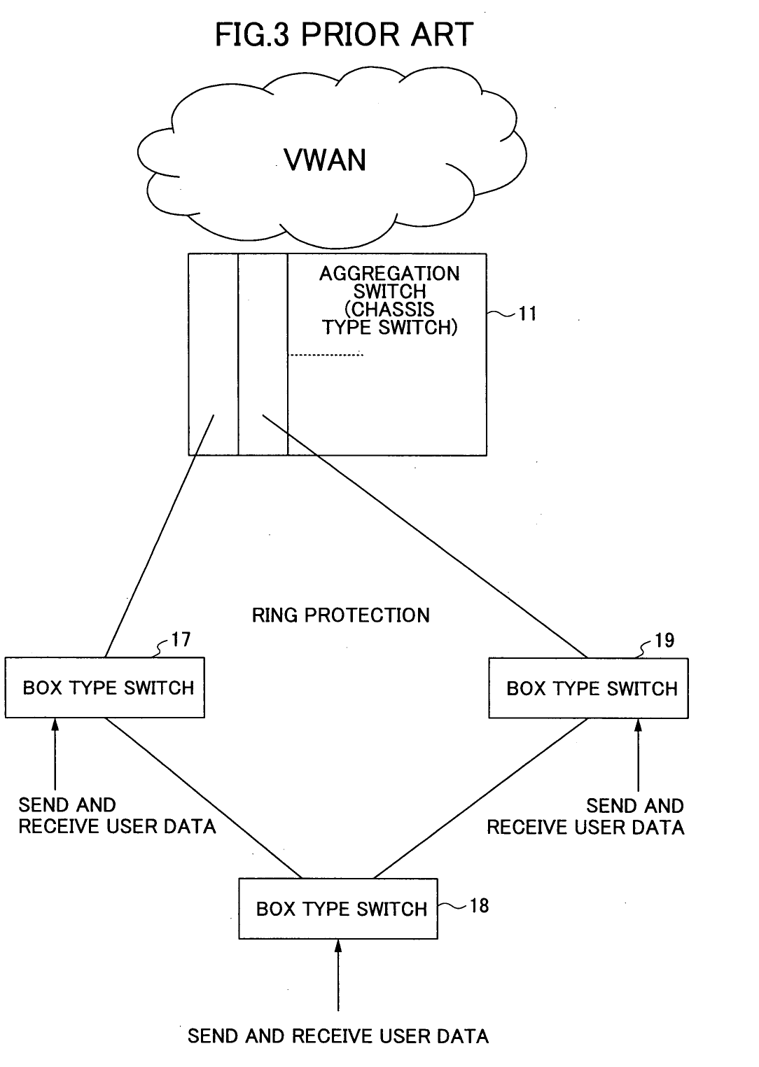

FIG. 4 shows a principle of a network to which the present invention is applied;

FIG. 5 is a block diagram of a box type switch according to an embodiment of the present invention;

FIG. 6 shows a flowchart of a learning table contents synchronization process;

FIG. 7 is a block diagram for explaining normal operation of a network to which the present invention is applied;

FIG. 8 is a block diagram for explaining a first embodiment of operation for access port failure in the box type switch;

FIG. 9 is a block diagram for explaining a second embodiment of operation for access port failure in the box type switch;

FIG. 10 is a block diagram for explaining a second embodiment of operation for network port failure in the box type switch;

FIG. 11 shows a format of a frame in which a VLAN tag is added.

### DETAILED DESCRIPTION OF THE PREFERRED EMBODIMENTS

In the following, embodiments of the present invention are described with reference to figures.

<Configuration of Network>

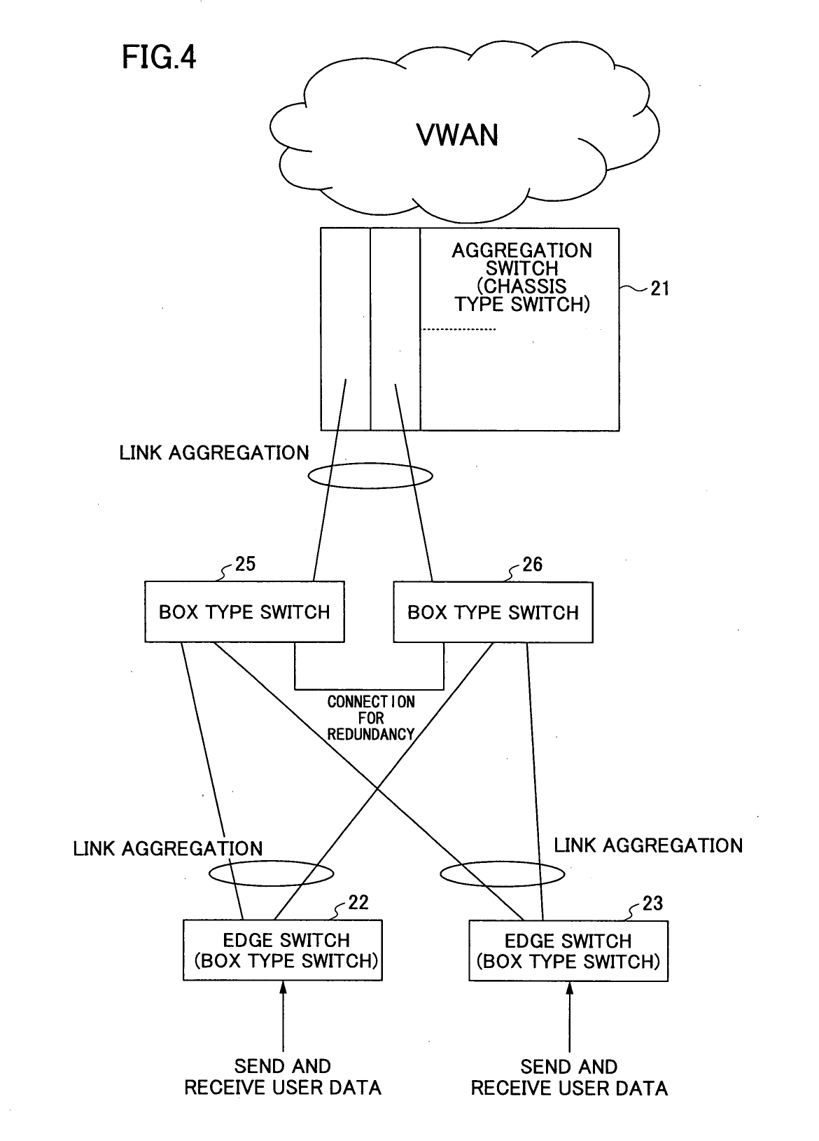

FIG. 4 shows a principle of a network to which the present invention is applied. As shown in the figure, a pair of box type switches 25 and 26 are added between an aggregation switch 21 that is an existing chassis type switch connected to a VWAN and edge switches 22 and 23 each being an existing box type switch for receiving and sending user data. The aggregation switch 21 is the upper switch apparatus, each of the box type switches 25 and 26 is the middle switch apparatus and each of the edge switches 22 and 23 is the lower switch apparatus.

In this embodiment, following configuration is adopted.

(1) Apparatus redundancy configuration is realized using the pair of box type switches 25 and 26.

(2) Connection setting in each of the aggregation switch 21 and the edge switches 22 and 23 for the pair of the box type switches 25 and 26 is link aggregation, each of the aggregation switch 21 and the edge switches 22 and 23 is connected to a port of a same port number in each of the box type switches 25 and 26.

(3) The box type switches 25 and 26 are connected using redundant ports (RP) that is not usually used.

(4) When any one of the box type switches 25 and 26 is failed, all ports of the failed box type switch are closed.

(5) When port failure occurs, traffic is diverted using the redundant ports of the box type switches 25 and 26. When diverting the traffic, loop is avoided by reporting input port information or output port information.

<Configuration of Box Type Switch>

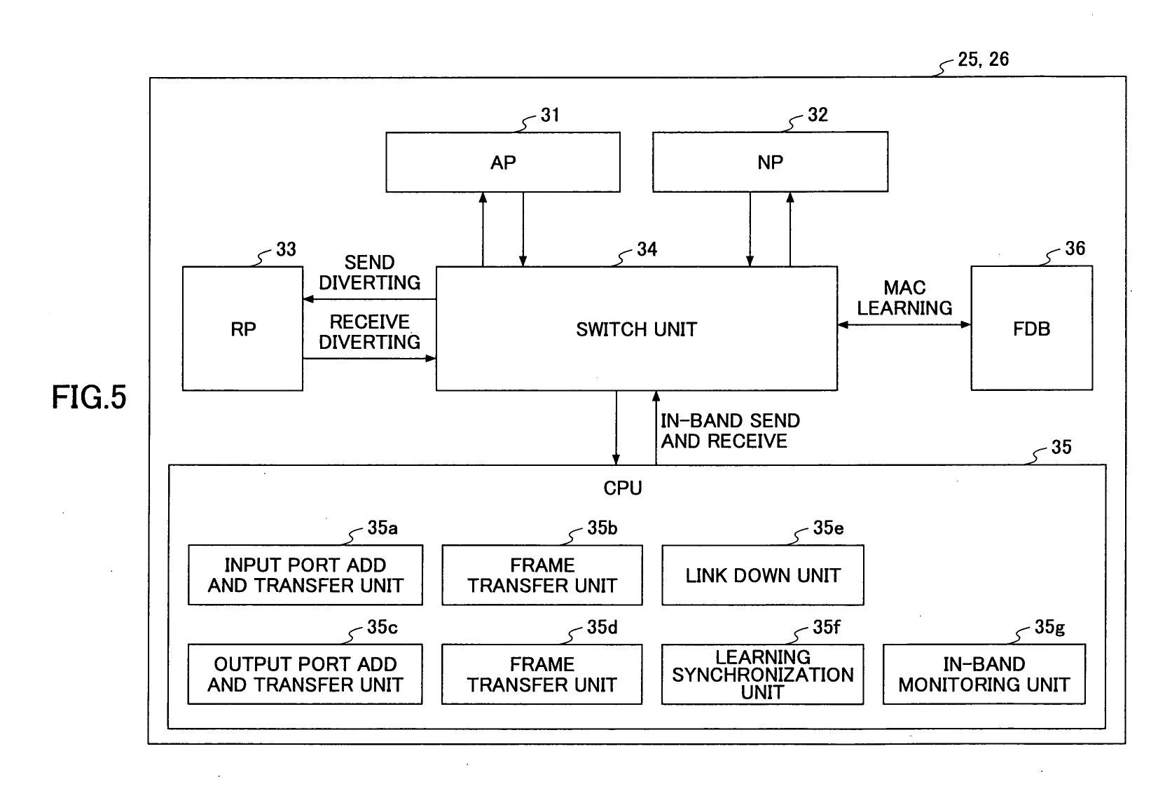

FIG. 5 is a block diagram of the box type switch (25 or 26) according to an embodiment of the present invention. The box type switch includes an access port (AP) 31, a network port (NP) 32, a redundant port (RP) 33, a switch unit 34, a CPU 35, and FDB (learning table) 36. The CPU 35 includes an input port add and transfer unit 35a, a frame transfer unit 35b, an output port add and transfer unit 35c, frame transfer unit 35d, a link down unit 35e, a learning synchronization unit 35f, and an in-band monitoring unit 35g, wherein these units are realized by executing an program by the CPU 35.

The access port 31 is connected to a lower switch apparatus, the network port 32 is connected to an upper switch apparatus, and the redundant port 33 is connected to a redundant port of another box type switch. The switch unit 34 switches connections among the access port 31, the network port 32 and the redundant port 33 based on control by the CPU 35.

In addition, learning of the FDB 35 is performed by the control of the CPU 35. Information in FDBs 36 are synchronized between the pair of box type switches 25 and 26 by the learning synchronization unit 35f. Further, the in-band monitoring unit 35g performs in-band monitoring.

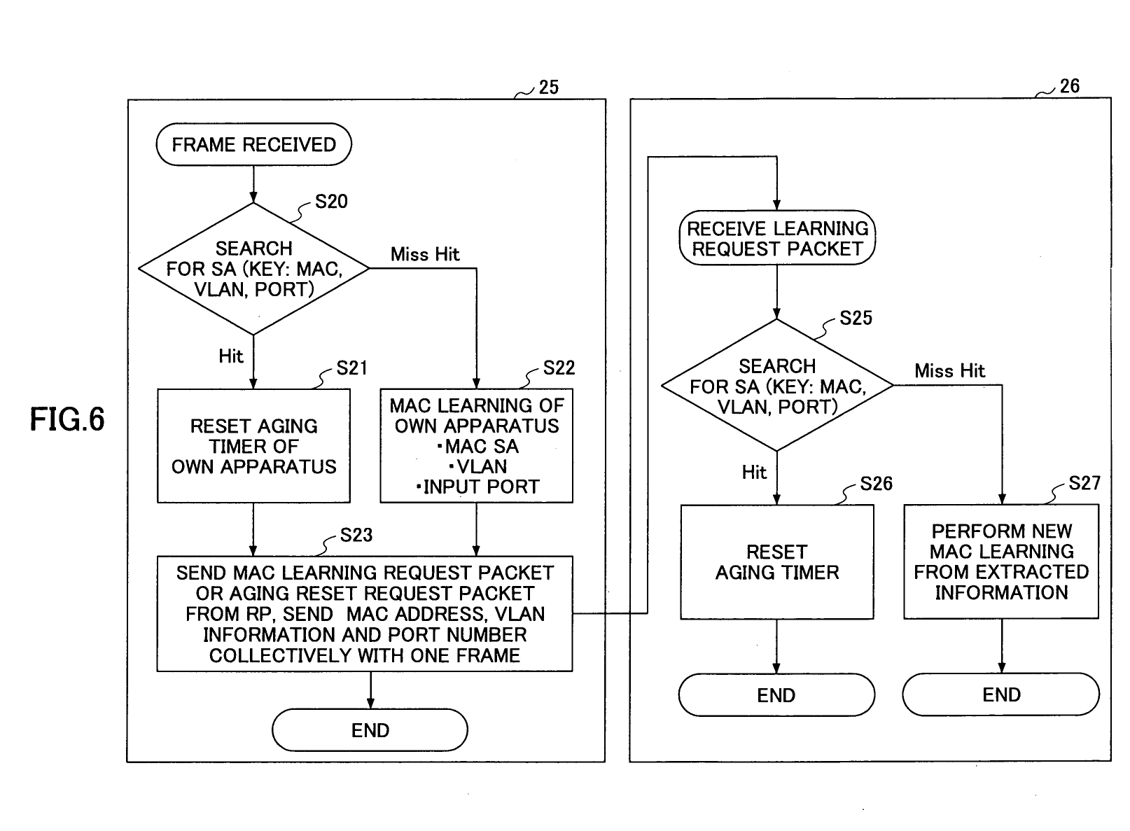

FIG. 6 shows a flowchart of a learning table contents synchronization process performed by the learning synchronization unit 35f. In the figure, a frame arrives at one (the box type switch 25 in this example) of the box type switches 25 and 26, the box type switch 25 searches the FDB 36 using a source MAC address (SA), VLAN information and an input port number of the received frame in step S20 so as to determine whether the FDB 36 stores the same MAC address, VLAN information and port number.

When the FDB 36 includes the same MAC address, VLAN information and port number, the box type switch 25 resets aging timer for an entry corresponding to the MAC address, the VLAN information and the port number. The aging timer is provided for performing aging process to delete an entry when the entry is not used for equal to or greater than a predetermined time.

On the other hand, when the same MAC address, VLAN information and port number are not stored in the FDB 36, the box type switch 25 stores the source MAC address (SA), the VLAN information and the input port number of the received frame into the FDB 36 to learn them in step S22.

After that, the box type switch 25 sends an aging timer reset request packet or a MAC learning request packet to another box type switch 26 in step S23. In this step, the box type switch 25 sends a plurality of pieces of learning information that are the MAC address (SA), the VLAN information, and the port number collectively with one frame.

When another box type switch 26 receives the aging timer reset request packet or the MAC learning request packet from the box type switch 25, the box type switch 26 searches the FDB 36 using the MAC address, the VLAN information and the port number reported by the aging timer reset request packet or the MAC learning request packet to determine whether the MAC address, the VLAN information and the port number are registered in the FDB 36.

When the FDB 36 stores the MAC address, the VLAN information and the port number, the box type switch 26 resets an aging timer for an entry corresponding to the MAC address and the VLAN information in step S26.

On the other hand, when the MAC address, the VLAN information and the port number are not stored in the FDB 36, the box type switch 26 stores the MAC address (SA), the VLAN information and the port number into the FDB 36 to learn them in step S27, so that contents in FDBs 36 between the box type switches 25 and 26 are synchronized.

Accordingly, when flooding is performed in one of the box type switches 25 and 26, flooding is unnecessary in another box type switch. Therefore, the number of times of flooding can be decreased.

<Normal Operation>

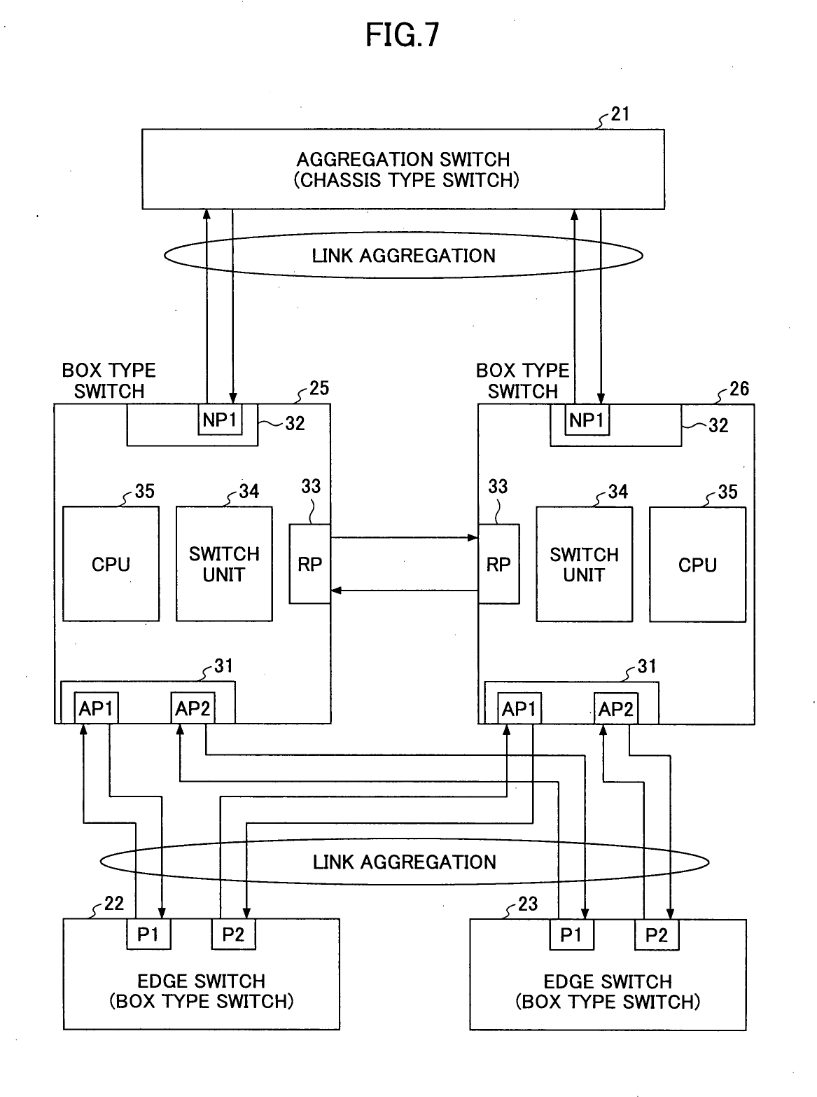

FIG. 7 shows a block diagram for explaining normal operation of a network to which the present invention is applied. In the figure, same signs are assigned to same units. As shown in FIG. 7, each of the aggregation switch 21 and the edge switches 22 and 23 is connected to a port of a same port number of each of the pair of box type switches 25 and 26.

For example, ports P1 and P2 of the aggregation switch 21 are connected to ports NP1 of the box type switches 25 and 26 respectively. Ports P1 and P2 of the edge switch 22 are connected to the same ports AP1 of the access ports 31 of the box type switches 25 and 26 respectively. Ports P1 and P2 of the edge switch 23 are connected to the same ports AP2 of the access ports 31 of the box type switches 25 and 26 respectively. In addition, the box type switches 25 and 26 are connected using the redundant ports (RP) 33.

Connection setting of the aggregation switch 21 for transmission lines between the aggregation switch 21 and the box type switches 25 and 26 is link aggregation, and also connection setting in each of the edge switches 22 and 23 for transmission lines between the edge switches 22, 23 and the box type switches 25, 26 is link aggregation.

Each of the CPUs 35 of the box type switches 25 and 26 periodically sends and receives a keep alive packet using the redundant ports 33 to check if another box type switch is normally operating.

In addition, when one of the box type switches 25 and 26 newly performs MAC address learning, the switch that performs the learning sends a learning request packet to another box type switch using the redundant port 33 so as to synchronize contents of the FDBs 36 between the box type switches 25 and 26. That is, information learned in one switch is sent to another switch for causing the another switch to learn the information.

The pair of box type switches 25 and 26 operates in the same way as a normal layer 2 switch using the access ports 31 and the network ports 32 other than the redundant ports 33. Also, VLAN information is set to the access ports 31 and the network ports 32 other than the redundant ports 33.

Traffic is carried between the upper aggregation switch 21 and the lower edge switch 22 via one of the box type switches 25 and 26 according to link aggregation. In the same way, traffic is carried between the upper aggregation switch 21 and the lower edge switch 23 via one of the box type switches 25 and 26 according to link aggregation. The edge switch 25 (or 26) that receives a frame from the aggregation switch 21 or the edge switch 22 performs normal switching process between the access port 31 and the network port 32 other than the redundant port 33.

### First Embodiment of Operation when Access Port Failure Occurs in the Box Type Switch

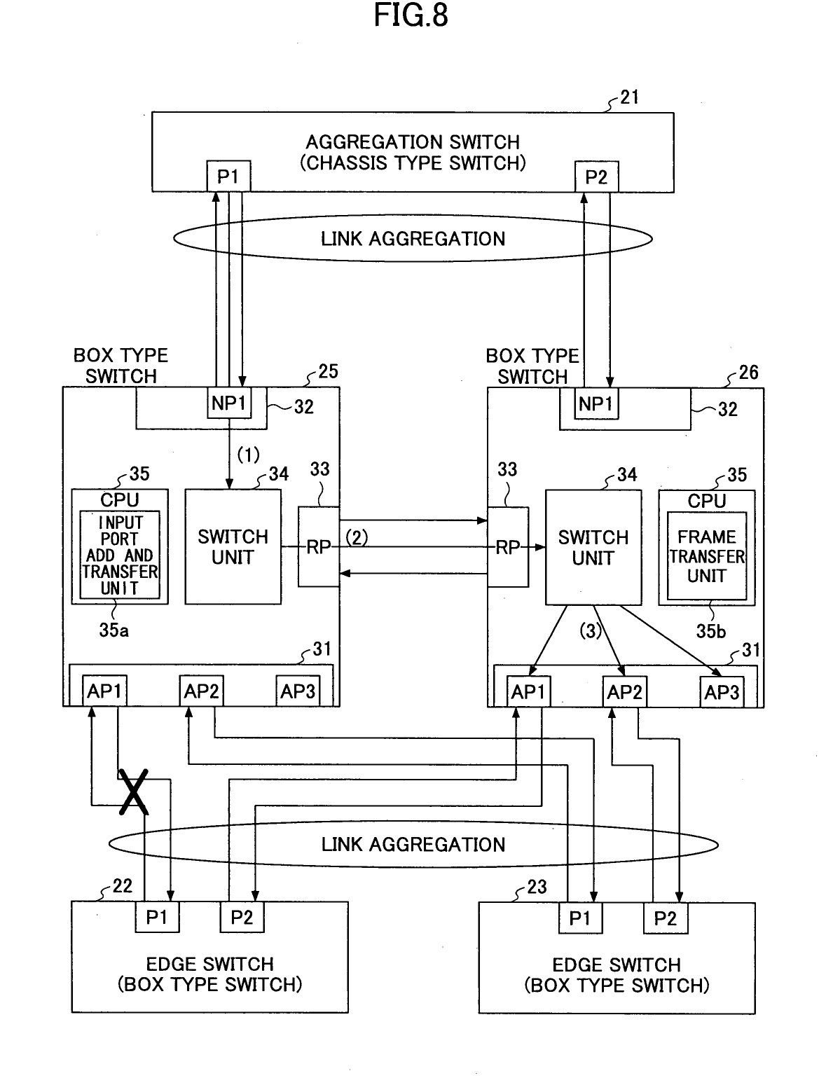

FIG. 8 shows a block diagram for explaining the first embodiment of operation for access port failure in the box type switch. In the figure, each number enclosed in parentheses corresponds to each number in the following description. By the way, similar operation is performed also when failure occurs such as cable disconnection of a line between the access port 31 of the box type switch and the edge switch.

When failure occurs in the port AP1 in the access port 31 in the box type switch 25, the CPU 35 of the box type switch 25 detects the failure of the port AP1.

After that, when a frame addressed to the port AP1 arrives at the network port 32 (port NP1, for example) of the box type switch 25 (1), the CPU 35 transfers the frame to the box type switch 26 via the switch unit 34 and the redundant port 33. By the way, in the case when a frame to the port AP1 occurs due to flooding, flooding is not performed in the box type switch 25, and the frame is transferred to the box type switch 26 via the switch unit 34 and the redundant port 33 like the frame addressed to the port AP1 (2).

At that time, the input port add and transfer unit 35a operating in the CPU 35 adds the port NP1 of the network port 32 to the frame to be transferred as input port information from which the frame is input using TPID field of a VLAN tag so as to transfer the frame with the input port information to the box type switch 26.

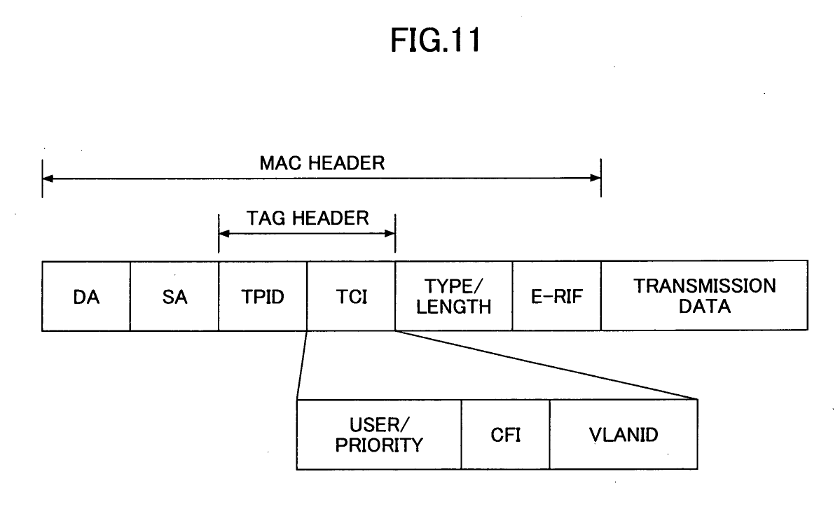

FIG. 11 shows a format of a frame in which the VLAN tag is added. As shown in the figure, the MAC header includes a destination MAC address (DA), a source MAC address (SA), a tag header, type/length, and E-RIF (Embedded Routing Information Field, and transmission data follows after that. The tag header includes TPID (Tag Protocol Identifier) and TCI (Tag Control Information). The TCI includes user priority, CFI (Canonical Format Indicator), and VLANID as the VLAN information.

The frame transfer unit 35b operating in the CPU 35 of the box type switch 26 extracts receiving port information (that is port NP1) from the VLAN tag of the frame received from the redundant port 33. Then, the box type switch 26 performs switching process similar to a process performed in the case when receiving a frame from the port NP1 of the box type switch 26 (3). In addition, when flooding is necessary for the frame, flooding is performed.

Accordingly, for example, a frame transferred to the box type switch 26 via the redundant port 33 from the box type switch 25 in which the port AP1 is failed is transmitted to the edge switch 22 from the port AP1 of the access port 31 of the box type switch 26.

When the failure at the port AP1 of the access port 31 of the box type switch 25 is recovered, the CPU 35 detects recovery of the port AP1. After that, when a frame addressed to the port AP1 in the access port 31 arrives at the access port 32 of the box type switch 25, the frame is transferred to the recovered port AP1 from the switch unit 34 to transmit the frame from the port AP1 to the edge switch 22.

### Second Embodiment of Operation when Access Port Failure Occurs in the Box Type Switch

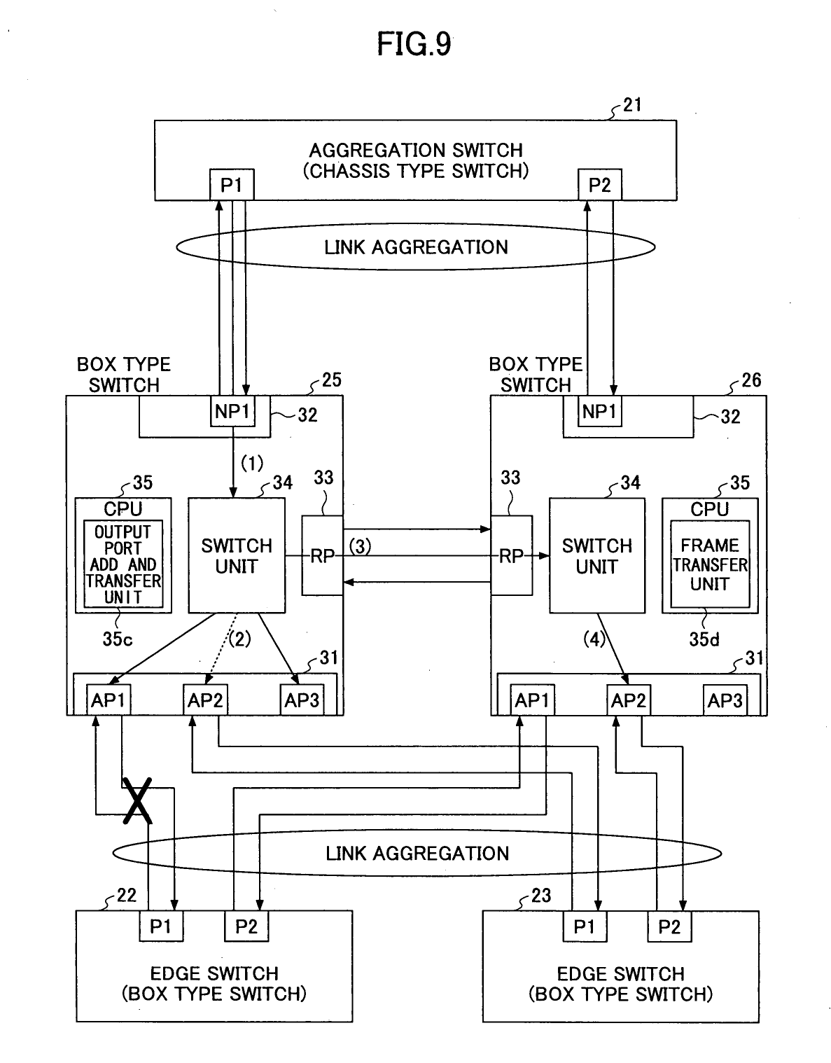

FIG. 9 shows a block diagram for explaining the second embodiment of operation for access port failure in the box type switch. In the figure, each number enclosed in parentheses corresponds to each number in the following description. By the way, similar operation is performed also when failure such as cable disconnection occurs in a line between the access port 31 of the box type switch and the edge switch.

When failure occurs in the port AP1 in the access port 31 in the box type switch 25, the CPU 35 of the box type switch 25 detects the failure of the port AP1.

After that, when a frame addressed to the port AP1 arrives at the network port 32 (port NP1, for example) of the box type switch 25 (1), the CPU 35 determines whether flooding is necessary for the frame. If it is necessary, the switch unit 34 in the box type switch 25 performs flooding (2). In this case, the received frame is flooded to ports AP1, AP2 and AP3 in the access port 31.

After flooding is performed, the box type switch 25 transfers the frame addressed to the failed port AP1 of the access port 31 to the box type switch 26 from the redundant port 33. When flooding is unnecessary, the CPU 35 transfers the frame addressed to the port AP1 to the box type switch 26 via the switch unit 34 and the redundant port 33 (3).

At that time, the input port add and transfer unit 35c operating in the CPU 35 adds the port AP1 of the network port 31 to the frame to be transferred as output port information from which the frame is output using TPID field of a VLAN tag so as to transfer the frame with the output port information to the box type switch 26.

The frame transfer unit 35d operating in the CPU 35 of the box type switch 26 extracts destination port information (that is port AP1) from the VLAN tag of the frame received from the redundant port 33. Then, the box type switch 26 performs switching process to transfer the frame to the port AP1 indicated by the extracted source port information (4). By the way, flooding is not performed in the box type switch 26.

Accordingly, for example, a frame transferred to the box type switch 26 via the redundant port 33 from the box type switch 25 in which the port AP1 is failed is transmitted to the edge switch 22 from the port AP1 of the access port 31 of the box type switch 26.

When the failure at the port AP1 of the access port 31 of the box type switch 25 is recovered, the CPU 35 detects recovery of the port AP1. After that, when a frame addressed to the port AP1 in the access port 31 arrives at the access port 32 of the box type switch 25, the frame is transferred to the recovered port AP1 from the switch unit 34 to transmit the frame from the port AP1 to the edge switch 22.

### First Embodiment of Operation of the Box Type Switch when Failure of Network Port Occurs

The first embodiment of operation of the box type switch for network port failure is described using FIG. 8. By the way, similar operation is performed also when failure such as cable disconnection occurs in a line between the network port 32 of the box type switch and the aggregation switch 21.

When failure occurs in the port NP1 in the network port 32 in the box type switch 25, the CPU 35 of the box type switch 25 detects failure of the port NP1.

After that, when a frame addressed to the port NP1 in the network port 32 arrives at the port AP1 in the network port 31 of the box type switch 25, the CPU 35 transfers the frame to the box type switch 26 via the switch unit 34 and the redundant port 33. By the way, in the case when a frame to the port NP1 occurs due to flooding, flooding is not performed in the box type switch 25, and the frame is transferred to the box type switch 26 via the switch unit 34 and the redundant port 33 like the frame addressed to the port NP1.

At that time, the input port add and transfer unit 35a operating in the CPU 35 adds the port AP1 of the access port 31 to the frame to be transferred as input port information from which the frame is input using TPID field of a VLAN tag so as to transfer the frame with the input port information to the box type switch 26.

The frame transfer unit 35b operating in the CPU 35 of the box type switch 26 extracts receiving port information (that is port AP1) from the VLAN tag of the frame received from the redundant port 33. Then, the box type switch 26 performs switching process similar to a process performed when receiving a frame from the port AP1 of the box type switch 26. In addition, when flooding is necessary for the frame, flooding is performed.

Accordingly, for example, a frame transferred to the box type switch 26 via the redundant port 33 from the box type switch 25 in which the port NP1 is failed is transmitted to the aggregate switch 21 from the port NP1 of the network port 32 of the box type switch 26.

When the failure at the port NP1 of the network port 32 of the box type switch 25 is recovered, the CPU 35 of the box type switch 25 detects recovery of the port NP1. After that, when a frame addressed to the port NP1 in the network port 32 arrives at the access port 31 of the box type switch 25, the frame is transferred to the recovered port NP1 from the switch unit 34 to transmit the frame from the port NP1 to the aggregate switch 21.

### Second Embodiment of Operation when Network Port Failure Occurs in the Box Type Switch

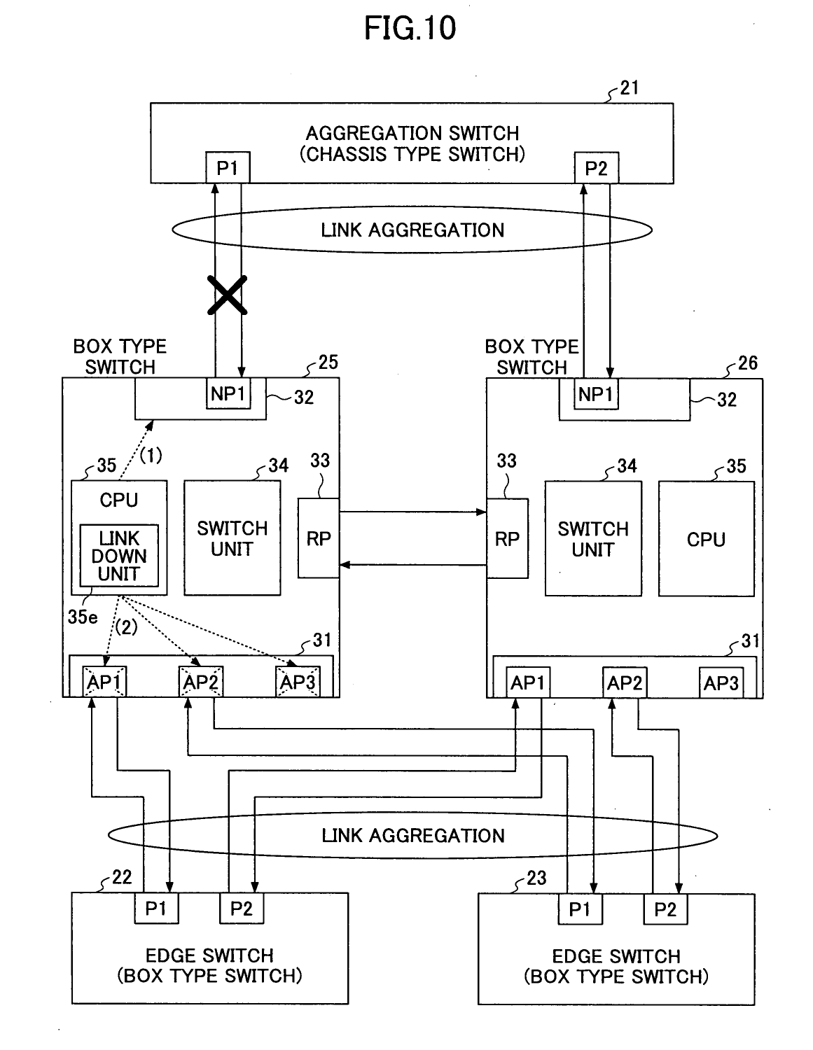

FIG. 10 shows a block diagram for explaining the second embodiment of operation for network port failure in the box type switch. In the figure, each number enclosed in parentheses corresponds to each number in the following description. By the way, similar operation is performed also when failure occurs such as cable disconnection in a line between the network port 32 of the box type switch and the aggregation switch 21.

When failure occurs in the port NP1 in the network port 32 in the box type switch 25, the CPU 35 of the box type switch 25 detects the failure of the port NP1. The link down unit 35e operating in the CPU 35 recognizes VLAN information set in the port NP1 of the network port 32 where the failure occurs (1), and sets each of ports AP1, AP2 and AP3 of the access port 31 to be in a link down status wherein the VLAN information is set in the ports AP1, AP2 and AP3 (2). Accordingly, the lower edge switch 22 is caused to detect link down.

When the lower edge switch 22 detects link down between the switch 22 and the box type switch 25, the lower edge switch 22 sends signals via the box type switch 26 where failure does not occur according to link aggregation function. Accordingly, signals can be sent and received between the aggregation switch 21 and the edge switch 22 by diverting signals around the failure point.

When failure in the port NP1 of the network port 32 of the box type switch 25 recovers, the CPU 35 of the box type switch 25 detects recovery of the port NP1. The link down unit 32e of the CPU 35 recognizes VLAN information set to the port NP1 that is recovered from the failure, and changes the status of each of the ports AP1, AP2 and AP3 of the access port 31 where the VLAN information is set into a link status.

After that, when a frame addresses to the port NP1 of the network port 32 arrives at the access port 31 of the box type switch 25, the frame is transferred to the recovered port NP1 from the switch unit 34, and is transmitted to the aggregation switch 21 from the port NP1.

### First Embodiment of Operation for Apparatus Failure of the Box Type Switch

The first embodiment of operation for apparatus failure of the box type switch is described with reference to FIG. 10. When apparatus failure occurs in the box type switch 25, the CPU 35 of the box type switch 25 detects it. The CPU 35 changes the state of every port of the access port 31 and the network port 32 into a link down state, and stops sending the keep alive packet from the redundant port 33 to another box type switch 26.

The another box type switch 26 detects that the keep alive packet is stopped so as to report it to an operator.

<In-Band Monitoring>

In the system of the present embodiment, when performing in-band monitoring in which monitoring information of a carrier is multiplexed to a transmission channel where user traffic is carried, each of the aggregation switch 21 and edge switches 22 and 23 does not necessarily transfer an in-band monitoring frame addressed to the box type switch 25 to the box type switch 25 since the switches 21-23 are connected to the box type switches 25 and 26 by link aggregation. That is, the in-band monitoring frame addressed to the box type switch 25 may be sent to the another box type switch 26. Therefore, the in-band monitoring is realized by a following way.

The in-band monitoring unit 35g operating in the CPU 35 of the box type switch 25 shown in FIG. 5 learns the MAC address of the box type switch 26 using the keep alive packet.

The in-band monitoring unit 35g of the box type switch 25 monitors frames transmitted over a in-band monitoring line using VLAN information, and identifies, from the frames, a frame having a MAC address of the another box type switch 26 as its destination MAC address (DA), a broadcast frame, a multicast frame, or a destination unknown unicast frame so as to copy the identified frame and transfer the frame to the another box type switch 26 using the redundant port 33. AT this time, information indicating that the frame is for in-band monitoring is added to TPID in VLAN tag of the frame.

The in-band monitoring unit 35g of the box type switch 26 receives the frame from the redundant port 33, and determines whether the frame is an in-band monitoring frame from TPID in VLAN tag of the frame. When the frame is the in-band monitoring frame, the CPU 35 processes the frame as data from a monitoring line to the box type switch 26.

In addition, the in-band monitoring unit 35g of the box type switch 25 transmits an in-band monitoring frame generated by the box type switch 25 via the network port 31 or the access port 32 without using the redundant port 33. However, when failure occurs at the network port 31 or the access port 32, the box type switch 25 transfer the generated in-band monitoring frame to the another box type switch 26 via the redundant port 33. At that time, input port information is not added to TPID of VLAN tag of the in-band monitoring frame to be transferred, or address of the CPU 35 of the box type switch 25 is added as the input port information.

The CPU 35 of the box type switch 26 receives the in-band monitoring frame from the redundant port 33, and determines that the frame is an in-band monitoring frame generated in the box type switch 25 if input port information is not added to the TPID of the VLAN tag of the frame, or if the address of the CPU 35 of the box type switch 25 is added, and sends the frame from the access port 31 or the network port 32 other than the redundant port 33 as usual.

Accordingly, a box type switch can be used as a middle switch apparatus to be added between an upper switch apparatus and a lower switch apparatus in order to increase the number of ports of the upper switch apparatus in a network in which the upper switch apparatus and the lower switch apparatus are connected by link aggregation. In addition, redundancy function can be provided. Further, setting change for existing apparatuses is not necessary so that effects to the service can be made minimum.

The present invention is not limited to the specifically disclosed embodiments, and variations and modifications may be made without departing from the scope of the present invention.

The present application contains subject matter related to Japanese patent application No. 2006-254421, filed in the JPO on Sep. 20, 2006, the entire contents of which are incorporated herein by reference.

What is claimed is:

1. A redundancy method used in a network including an upper switch apparatus, a pair of middle switch apparatuses connected to the upper switch apparatus, and a plurality of lower switch apparatuses connected to each of the pair of middle switch apparatuses, wherein:
each of the upper switch apparatus and the lower switch apparatuses is connected to ports of a same port number of the pair of the middle switch apparatuses by setting link aggregation;
the pair of the middle switches are connected to each other via redundancy ports;
when failure occurs at a port, connected to the lower switch apparatus, of one middles switch apparatus of the pair of the middle switch apparatuses, the one middle switch apparatus adds input port information to a frame addressed to the failed port to transfer the frame with the input port information to another middle switch apparatus of the pair from the redundancy port; and
the another middle switch apparatus receives the frame with the input port information from the redundancy port and transfers the frame in accordance with the input port information.

2. A redundancy method used in a network including an upper switch apparatus, a pair of middle switch apparatuses connected to the upper switch apparatus, and a plurality of lower switch apparatuses connected to each of the pair of the middle switch apparatuses, wherein:
each of the upper switch apparatus and the lower switch apparatuses is connected to ports of a same port number of the pair of the middle switches by setting link aggregation;
the pair of the middle switches are connected to each other via redundancy ports;
when failure occurs at a port, connected to the lower switch apparatus, of one middle switch apparatus of the pair of the middle switch apparatuses, the one middle switch apparatus adds output port information to a frame addressed to the failed port to transfer the frame with the output port information to another middle switch apparatus of the pair from the redundancy port; and
the another middle switch apparatus receives the frame with the output port information from the redundancy port and transfers the frame in accordance with the output port information.

3. The redundancy method as claimed in claim 1, wherein,
when failure occurs at a port connected to the upper switch in the one middle switch apparatus of the pair, the one middle switch apparatus detects a virtual network identifier set for the failed port, and sets an access port, where the virtual network identifier is set, connected to the lower switch apparatus to be in a link down status.

4. The redundancy method as claimed in claim 2, wherein,
when failure occurs at a port connected to the upper switch in the one middle switch apparatus of the pair, the one middle switch apparatus detects a virtual network identifier set for the failed port, and sets an access port, where the virtual network identifier is set, connected to the lower switch apparatus to be in a link down status.

5. A middle switch apparatus in a network including an upper switch apparatus, a pair of middle switch apparatuses, including the middle switch apparatus, connected to the upper switch apparatus, and a plurality of lower switch apparatuses connected to each of the pair of the middle switch apparatuses, comprising:
an input port add and transfer unit configured to, when failure occurs in a port connected to the lower switch apparatus, add input port information of a frame addressed to the failed port to the frame so as to transfer the frame with the input port information to a redundancy port of another middle switch apparatus from a redundancy port of the middle switch apparatus; and
a frame transfer unit configured to receive the frame with the input port information so as to transfer the frame in accordance with the input port information.

6. A middle switch apparatus in a network including an upper switch apparatus, a pair of middle switch apparatuses, including the middle switch apparatus, connected to the upper switch apparatus, and a plurality of lower switch apparatuses connected to each of the pair of the middle switch apparatuses, comprising:
an output port add and transfer unit configured to, when failure occurs in a port connected to the lower switch apparatus, add output port information of a frame addresses to the failed port to the frame so as to transfer the frame with the output port information to a redundancy port of another middle switch apparatus from a redundancy port of the middle switch apparatus; and
a frame transfer unit configured to receive the frame with the output port information so as to transfer the frame in accordance with the output port information.

7. The middle switch apparatus as claimed in claim 5, wherein, when failure occurs in a port connected to the upper switch apparatus, the input port add and transfer unit adds input port information of a frame addressed to the failed port to the frame so as to transfer the frame with the input port information to another middle switch apparatus from the redundancy port, and
the frame transfer unit transfers the frame received from the redundancy port in accordance with the input port information.

8. The middle switch apparatus as claimed in claim 5, the middle switch apparatus further comprising a link down unit configured to, when failure occurs in a port connected to the upper switch apparatus, detect virtual network identifier set for the failed port so as to set an access port, where the virtual network identifier is set, connected to the lower switch apparatus to be in a link down status.

9. The middle switch apparatus as claimed in claim 6, the middle switch apparatus further comprising a link down unit configured to, when failure occurs in a port connected to the upper switch apparatus, detect virtual network identifier set for the failed port so as to set an access port, where the virtual network identifier is set, connected to the lower switch apparatus to be in a link down status.

10. The middle switch apparatus as claimed in claim 5, further comprising:
a learning request unit configured to, when updating a learning table, send a learning request including updated information of the learning table to another middle switch of the pair from the redundancy port; and
a learning table updating unit configured to update the learning table using updated information included in a learning request received from the redundancy port.

11. The middle switch apparatus as claimed in claim 6, further comprising:
a learning request unit configured to, when updating a learning table, send a learning request including updated information of the learning table to another middle switch of the pair from the redundancy port; and
a learning table updating unit configured to update the learning table using updated information included in a learning request received from the redundancy port.

12. The middle switch apparatus as claimed in claim 5, further comprising:
an in-band monitoring unit configured to monitor frames transmitted over an in-band monitoring line to send a frame addressed to another middle switch apparatus of the pair to the another middles switch apparatus from the redundancy port.

13. The middle switch apparatus as claimed in claim 6, further comprising:
an in-band monitoring unit configured to monitor frames transmitted over an in-band monitoring line to send a frame addressed to another middle switch apparatus of the pair to the another middles switch apparatus from the redundancy port.
